(19) United States
(12) Patent Application Publication
(10) Pub. No.: US 2006/0127062 A1
(43) Pub. Date: Jun. 15, 2006

(54) Image recording apparatus having a title information creation function and a title information creation method for using the same

(75) Inventor: Eun Mi Kim, Gyeonggi-Do (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/242,077

(22) Filed: Oct. 4, 2005

(30) Foreign Application Priority Data
Dec. 15, 2004 (KR) 2004-106669

(51) Int. Cl. H04N 5/85

(52) U.S. Cl. 386/126

(57) ABSTRACT

An image recording apparatus having a title information creation function and a title information creation method using the same are provided. The image recording apparatus records an image on a digital versatile disc (DVD) and finalizes the DVD for compatibility between the DVD and a player. The title information creation method comprises determining whether title information has been correctly recorded on the DVD before the finalization, and creating the title information using different information recorded on the DVD if the title information has not been correctly recorded.

### CROSS-REFERENCE TO RELATED APPLICATION

This application claims the benefit under 35 U.S.C. 119(a) of Korean Patent Application No. 2004-106669, filed on Dec. 15, 2004 in the Korean Intellectual Property Office, the entire disclosure of which is incorporated herein by reference.

### BACKGROUND OF THE INVENTION

1. Field of the Invention

The present invention relates to an image recording apparatus having a title information creation function and a title information creation method using the same. More particularly, the present invention relates to an image recording apparatus having a title information creation function of, where title information is not correctly recorded on a digital versatile disc (DVD) when data is recorded on the DVD, creating the title information before finalization of the disc, and a title information creation method using the same.

2. Description of the Related Art

Recently, consumers have begun using DVD recorders for recording television broadcasts and photographed images, instead of video tape recorders. The DVDs use recording media, recording DVDs, which may be, for example, a DVD-recordable (DVD-R) for writing once, a DVD-rewriteable (DVD-RW) appropriate to video recording, a DVD-random access memory (DVD-RAM) appropriate to for computer data recording, and so forth.

Conventionally, even though an image is recorded on a recording DVD, such as the DVD-R/RW, in a DVD-video format by a DVD recorder, it is reproduced or played not by a general DVD player, but only by the same type of DVD recorder. In order to overcome this problem, a new-type of DVD recorder was introduced to the market in 2000, which records an image on the DVD-R/RW in the DVD-video format so that the recorded image can be reproduced or played by a general DVD player or a different-type DVD recorder.

Typically, a DVD recorder finalizes a disc after recording an image thereon. The finalization is a process of inhibiting further recording of a recording disc, such as the DVD-R/RW, and creating a visual index of the recorded image. Details of this finalization are disclosed in Korean Patent Laid-open Publication No. 10-1998-032556 and 10-2003-0065160, the contents of which are incorporated herein by reference.

When an image is recorded on the DVD-R/RW in the DVD-video format, it is stored in a plurality of video title sets (VTSs) (up to 99 titles can be recorded) as shown in Korean Patent Registration Publication No. 10-0221429, the contents of which are incorporated herein by reference. Each of the VTSs is composed of video title set information (VTSI) that is title management information, a video object set (VOBS) that contains video data and audio data, and a backup of the video title set information (VTSI_BUP). Different DVD recorders or general DVD players can reproduce the recorded image using the VTSI, and so on.

However, such a conventional DVD recorder is disadvantageous in that the finalization is performed even under the condition that the VTSI is not normally recorded after the image is recorded on the DVD-R/RW in the DVD-video format, so that general DVD players, different DVD recorders or PCs cannot recognize the VTSI and thus reproduce the recorded image.

In this case, the DVD-R is no longer available. If a DVD recorder fails to find the VTSI, it may result in the DVD drive opening i.e., the DVD recorder may eject the DVD-RW, thereby making it impossible to reuse the DVD-RW.

### SUMMARY OF THE INVENTION

Therefore, it is an aspect of the invention to provide an image recording apparatus having a title information creation function of, when title information is incompletely recorded on a DVD, creating the title information using other information recorded on the DVD before finalization of the disc, and a title information creation method using the same.

Additional aspects and/or advantages of the invention will be set forth in part in the description which follows and, in part, will be obvious from the description, or may be learned by practice of the invention.

In accordance with the invention, the above and/or other aspects can be achieved by the provision of a title information creation method of an image recording apparatus which records an image on a digital versatile disc (DVD) and finalizes the DVD for compatibility between the DVD and a player, comprising determining whether title information has been correctly recorded on the DVD before the finalization; and creating the title information using different information recorded on the DVD if the title information has not been correctly recorded

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram showing the configuration of a digital versatile disc (DVD) recorder according to an embodiment of the present invention;

FIG. 2 is a view showing a logical data structure of a DVD-video disc;

FIG. 3 is a detailed view of a video manager (VMG) in FIG. 2;

FIG. 4 is a detailed view of a video object set (VOBS) in FIG. 3;

FIG. 5 is a detailed view of a data search information (DSI) contained in a navigation pack (NV_PCK) in FIG. 4;

FIG. 6 is a detailed view of a data search information general information (DSI_GI) format shown in FIG. 5;

FIG. 7 is a detailed view of a video title set (VTS) in FIG. 2;

FIG. 8 is a detailed view of a video title set information manager table (VTSI_MAT) in FIG. 7;

FIG. 9 is a detailed view of a video title set part of title search pointer table (VTS_PTT_SRPT) in FIG. 7;

FIG. 10 is a detailed view of a program chain (PGC);

FIG. 11 is a detailed view of a video title set program chain information table (VTS_PGCIT) in FIG. 7;

FIG. 12 is a detailed view of a VTS cell address table (VTS_C_ADT) in FIG. 7;

FIG. 13 is a detailed view of a video title set video object unit address map (VTS_VOBU_ADMAP) in FIG. 7;

FIG. 14 is a flow chart illustrating a method for, by the DVD recorder of FIG. 1, determining whether title information has been correctly recorded on a DVD-R/RW before finalization and creating the title information if it has not been correctly recorded in accordance with an embodiment of the present invention; and

FIG. 15 is a flow chart illustrating in detail an operation in FIG. 14 of creating the title information using information of the NV_PCK in accordance with an embodiment of the present invention.

Throughout the drawings, the same or similar elements, features and structures are represented by the same reference numerals.

### DETAILED DESCRIPTION OF EXEMPLARY EMBODIMENTS

Reference will now be made in detail to the embodiments of the present invention, examples of which are illustrated in the accompanying drawings.

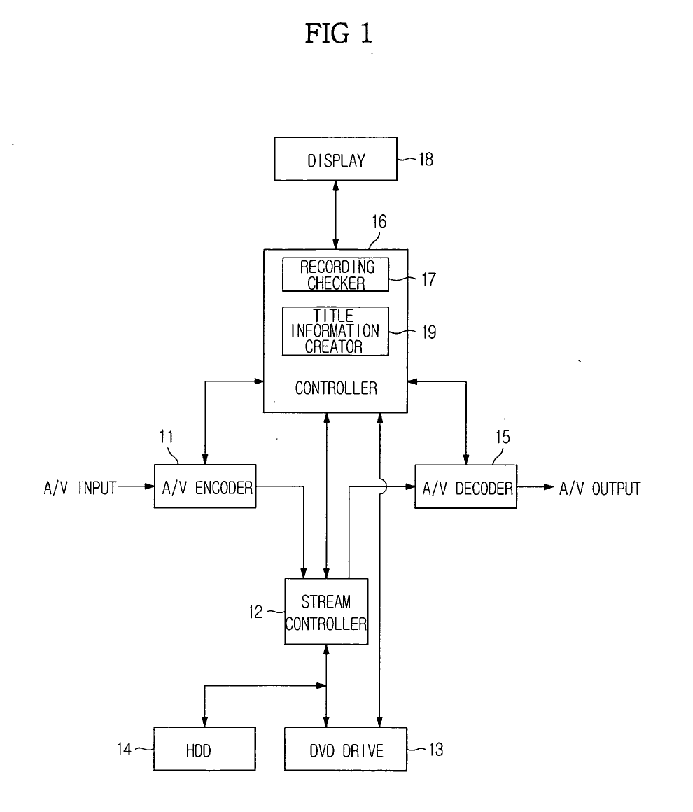

FIG. 1 is a block diagram showing the configuration of a digital versatile disc (DVD) recorder according to an embodiment of the present invention. As shown in this drawing, the DVD recorder comprises an audio/video (A/V) encoder 11 for compressing an A/V signal input through an AV input terminal using a motion picture expert group-2 (MPEG-2) scheme, a stream controller 12 for controlling the flow of an A/V data stream from the AV encoder 11, a DVD drive 13 for loading a DVD therein and recording or reproducing an A/V data stream on or from the DVD, a hard disk drive (HDD) 14, an A/V decoder 15 for decoding an A/V data stream, a display 18, and a controller 16 for controlling the above-mentioned components. The controller 16 comprises a recording checker 17 for checking title information recorded on the DVD, and a title information creator 19 for creating title information, not recorded on the DVD. Here, the title information refers to a video title set information (VTSI).

In this DVD recorder, when an A/V signal is input to the AN input terminal in a recording mode, it is compressed using the Moving Picture Experts Group 2 (MPEG-2) scheme and then stored on the DVD in the form of a bit stream. In a playback mode, a bit stream stored on the DVD is read, decoded by the AN decoder 15 and then displayed as an image through a graphic user interface (GUI) (not shown) connected to the DVD recorder.

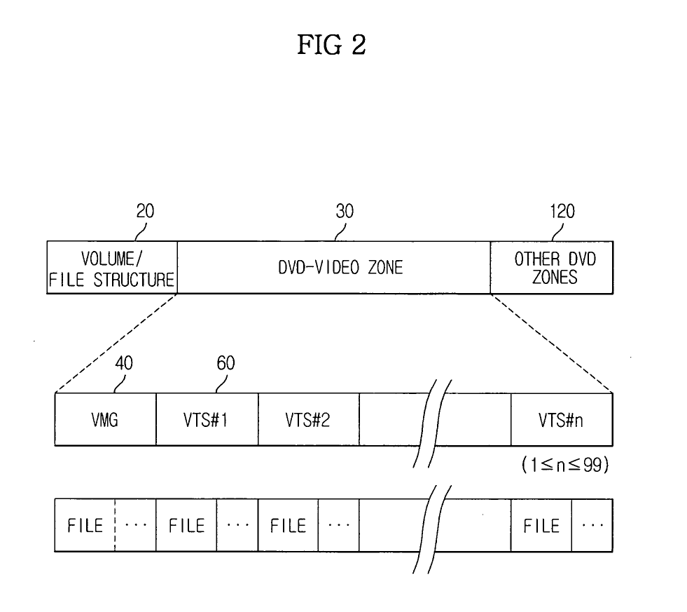

FIG. 2 shows a logical data structure of a conventional DVD-video disc. As shown in this drawing, the DVD-video disc is divided into a volume/file structure 20, a DVD-video zone 30, and other DVD zones 120. The DVD-video zone 30 is subdivided into a video manager (VMG) 40 and a plurality of VTSs 60. The VMG 40 is created by finalization and is composed of a plurality of files that store information managing the VTSs 60. As will be described later in detail, the VTSs 60 store video data, audio data and sub-picture data, and up to 99 VTSs can be created in one DVD-video zone 30. The volume/file structure 20 is a management area which is defined by a universal disk format (UDF) bridge.

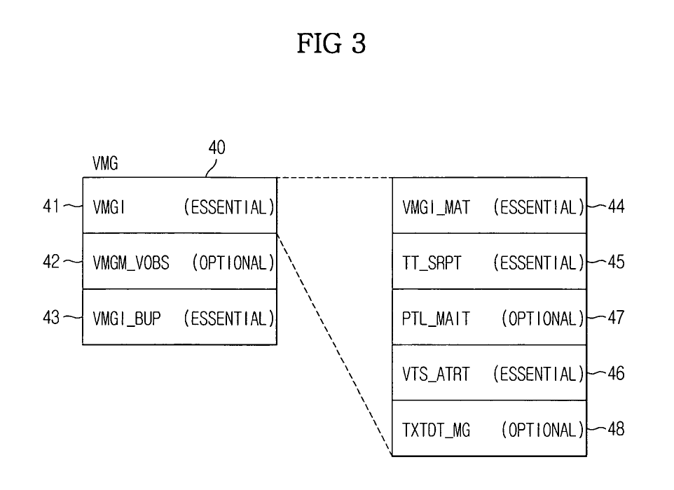

The VMG 40 has, as shown in FIG. 3, video manager information (VMGI) 41, a video object set for a video manager menu (VMGM_VOBS) 42, and a backup of the VMGI 41 (VMGI_BUP) 43. Here, the VMGI 41 and VMGI_BUP 43 are essential items and the VMGM_VOBS 42 is an optional item.

The VMGI 41 is located at the head of the VMG 40 and contains control information on the whole of the DVD-video zone 30. To this end, the VMGI 41 has essential items, a VMGI management table (VMGI_MAT) 44 having information of the VMG 40, a title search pointer table (TT_SRPT) 45 having title search information, and a VTS attribute table (VTS_ATRT) 46 having attribute information of the VTSs 60. The VMGI 41 further has optional items such as a parental management information table (PTL_MAIT) 47 and a text data manager (TXTDT_MG) 48.

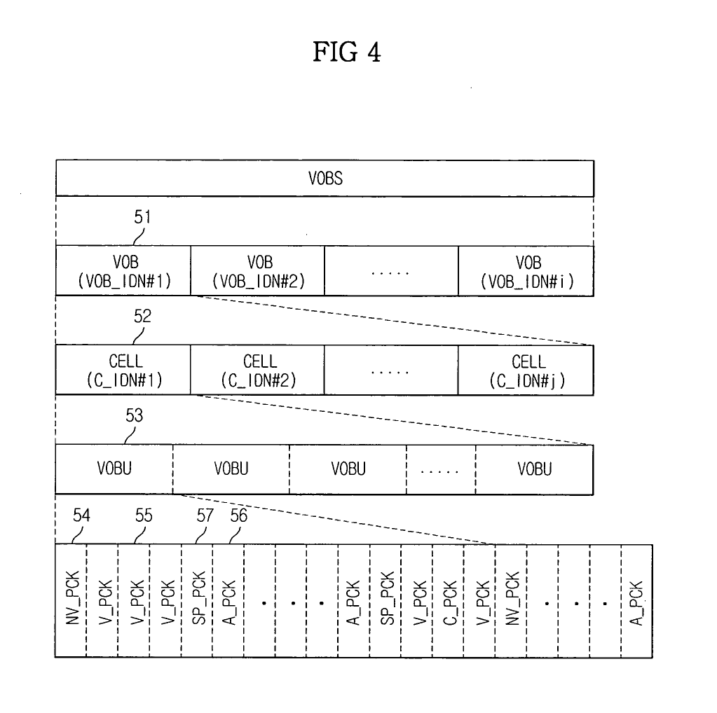

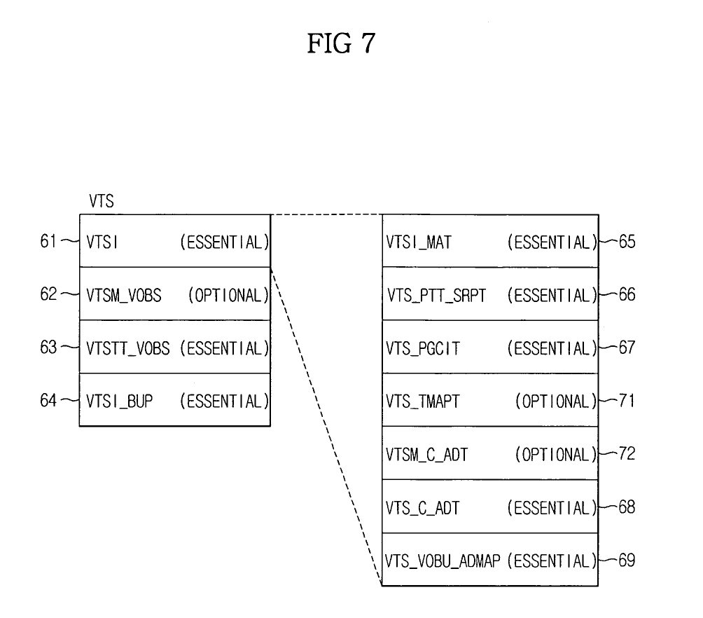

The VMGM_VOBS 42 is a content for a title selection menu, which is composed of a plurality of video objects (VOBs) 51, as shown in FIG. 4. For reference, besides the VMGM_VOBS 42, there are provided other VOBSs, a VOBS for a VTSM (VTSM_VOBS) (62 in FIG. 7) and a VOBS for a video title set title (VTSTT_VOBS) (63 in FIG. 7) included in each VTS. These VOBSs are used for different purposes, but have the same structures.

Each of the VOBs 51 comprising the VOBS is assigned an identification (ID) number VOB_IDN #i to specify a corresponding one of the VOBs 51. Each VOB 51 comprises at least one cell 52, which is assigned an ID number C_IDN #j similar to the VOB 51.

As shown in FIG. 4, the cell 52 is composed of at least one video object unit (VOBU) 53, which is a pack train comprising one navigation pack (NV_PCK) 54 placed at the head thereof, and video packs (V_PCK) 55, audio packs (A_PCK) 56 and sub-picture packs (SP_PCK) 57 placed subsequently to the NV_PCK 54. That is, the VOBU 53 can be considered to be a set of packs from one NV_PCK 54 to the next NV_PCK 54. Here, the playback time of the VOBU 53 is equal to that of video data contained in the VOBU 53, which is set to any value within the range of 0.4 to 1 sec.

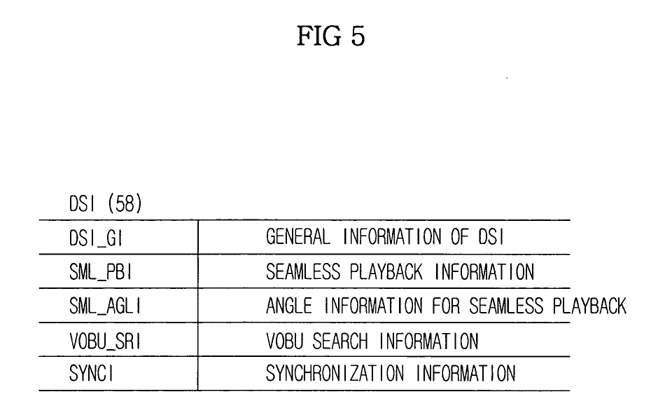

The NV_PCK comprises presentation control information (PCI) (not shown) which is navigation data for control of presentation of the VOBU 53, and data search information (DSI) (58) which is navigation data for search and seamless playback of the VOBU 53. The DSI 58 comprises general information of the DSI 58 (DSI_GI), seamless playback information (SML_PBI), angle information for seamless playback (SML_AGLI), VOBU search information (VOBU_SRI) and synchronization information (SYNCI), as shown in FIG. 5.

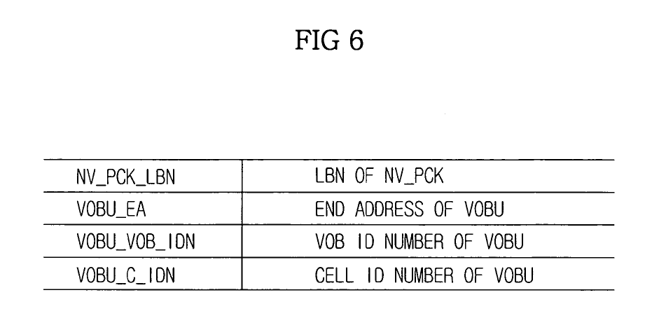

The DSI_GI has items as shown in FIG. 6, NV_PCK_LBN, VOBU_EA, VOBU_VOB_IDN and VOBU_C_IDN. The NV_PCK_LBN is an address of the NV_PCK where the DSI 58 is located, which is represented by the number of relative logical blocks from a leading logical block of the VOBS where the DSI 58 is located. The VOBU_EA is an end address of the VOBU 53. The VOBU_VOB_IDN is a VOB ID number of the VOBU 53, and the VOBU_C_IDN is a cell ID number of the VOBU 53.

Each VTS 60 comprises as shown in FIG. 7, VTS information (VTSI) 61 that is control information for the VTS, a VOBS for a VTS menu (VTSM_VOBS) 62 that is a content for various menus in the VTS, a VOBS for a VTS title (VTSTT_VOBS) 63 that is a content for title playback, and VTSI for backup (VTSI_BUP) 64 that is a complete copy of the VTSI 61. Here, the VTSI 61, VTSTT_VOBS 63 and VTSI_BUP 64 are essential items, whereas the VTSM_VOBS 62 is an optional item.

The VTSI 61 has, as shown in FIG. 7, essential items, a VTSI manager table (VTSI_MAT) 65, a video title set part_of_title search pointer table (VTS_PTT_SRPT) 66, a video title set program chain information table (VTS_PGCIT) 67, a VTS cell address table (VTS_C_ADT) 68 and a VTS video object unit address map (VTS_VOBU_ADMAP) 69, and optional items, VTS_TMAPT 71 and VTSM_C_ADT 72.

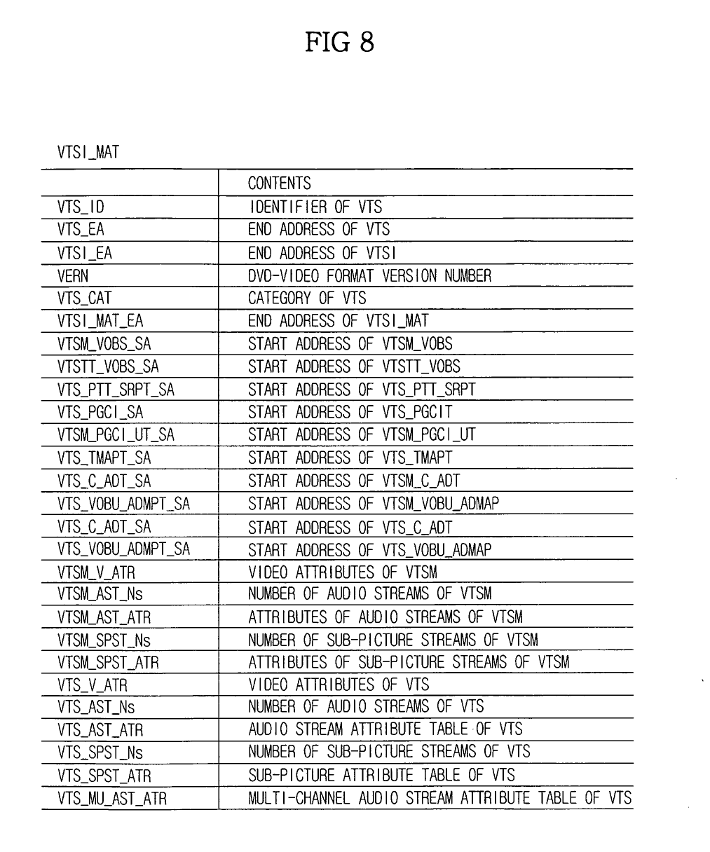

The VTSI_MAT 65 comprises the size of the VTS 60, a start address of each information in the VTS 60, and attributes of the VOBSs 62 and 63 in the VTS 60. That is, as shown in FIG. 8, described in the VTSI_MAT 65 are an identifier of the VTS 60 (VTS_ID), an end address of the VTS 60 (VTS_EA), an end address of the VTSI 61 (VTSI_EA), a DVD-video format version number (VERN), a category of the VTS 60 (VTS_CAT), an end address of the VTSI_MAT 65 (VTSI_MAT_EA), a start address of the VTSM_VOBS 62 (VTSM_VOBS_SA), and a start address of the VTSTT_VOBS 63 (VTSTT_VOBS_SA). Here, the VTSI_MAT_EA is represented by the number of relative logical blocks from a leading byte of the VTSI_MAT 65, and the VTSM_VOBS_SA and VTSTT_VOBS_SA are each represented by the number of relative logical blocks (RLBN) from a leading logical block of the VTS 60. When there is no VTSM_VOBS 62 in the VTS 60, “0” is described as the VTSM_VOBS_SA.

Also described in the VTSI_MAT 65 are a start address of the VTS_PTT_SRPT (VTS_PTT_SRPT_SA), a start address of the VTS_PGCIT (VTS_PGCIT_SA), a start address of VTSM_PGCI_UT (VTSM_PGCI_UT_SA), a start address of the VTS_TMAPT (VTS_TMAPT_SA), a start address of the VTSM_C_ADT (VTSM_C_ADT_SA), a start address of VTSM_VOBU_ADMAP (VTSM_VOBU_ADMAP_SA), a start address of the VTS_C_ADT (VTS_C_ADT_SA), and a start address of the VTS_VOBU_ADMAP (VTS_VOBU_ADMAP_SA), each of which is represented by the number of relative logical blocks from a leading logical block of the VTSI 61.

Also described in the VTSI_MAT 65 are video attributes of the VTSM (VTSM_V_ATR), the number of audio streams of the VTSM (VTSM_AST_Ns), attributes of the audio streams of the VTSM (VTSM_AST_ATR), the number of sub-picture streams of the VTSM (VTSM_SPST_Ns), and attributes of the sub-picture streams of the VTSM (VTSM_SPST_ATR).

Also described in the VTSI_MAT 65 are video attributes of the VTS 60 (VTS_V_ATR), the number of audio streams of the VTS 60 (VTS_AST_Ns), an audio stream attribute table of the VTS 60 (VTS_AST_ATRT), the number of sub-picture streams of the VTS 60 (VTS_SPST_Ns), a sub-picture attribute table of the VTS 60 (VTS_SPST_ATRT), and a multi-channel audio stream attribute table of the VTS 60 (VTS_MU_AST_ATRT).

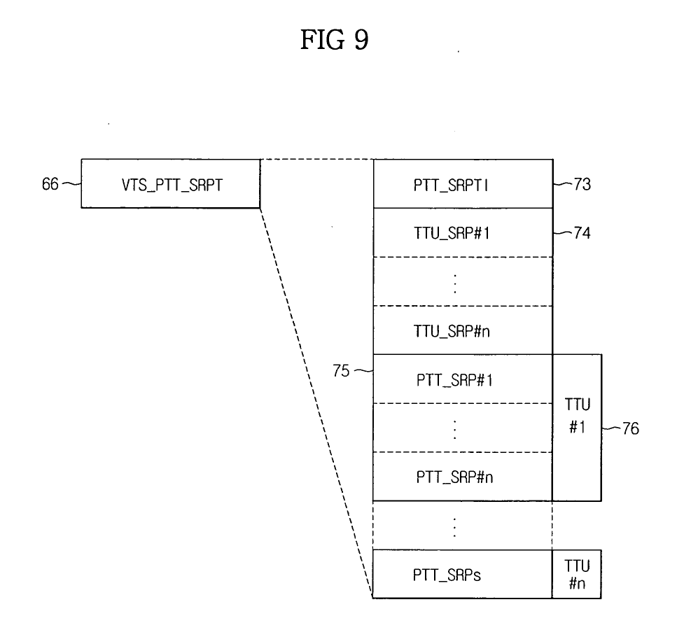

PTT search pointer table information (PTT_SRPTI) 73, title unit search pointers (TTU_SRP) 74, and PTT search pointers (PTT_SRP) 75 are described in the VTS_PTT_SRPT 66, as shown in FIG. 9. Here, the part of title (PTT) is a title start position, which is specified by a PTT search pointer.

The PTT_SRPTI 73 comprises the number of title units (TTUs) 76 in the VTS 60 and an end address of the VTS_PTT_SRPT 66. Each TTU_SRP 74 stores a start address of a corresponding one of the TTUs 76, and each PTT_SRP 75 stores a program chain number (PGCN) and a program number (PGN). Here, each TTU 76 is a group of PTT_SRP 75 for an associated title.

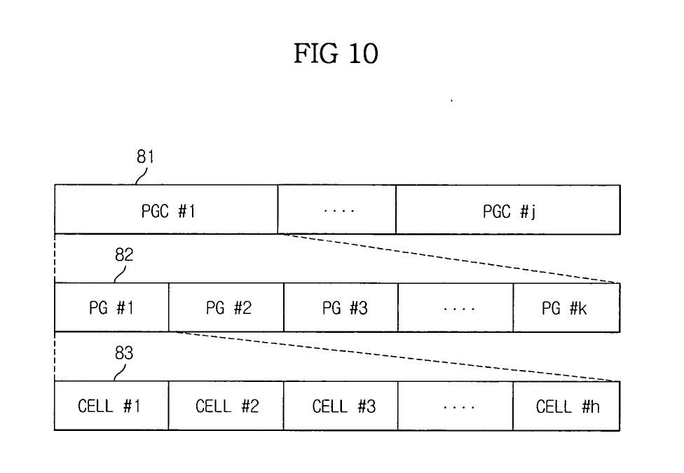

Each PGC 81 is a logical unit representing all or part of a title and is a group of programs that reproduce a story of the title. In this regard, as shown in FIG. 10, the PGC 81 comprises a plurality of programs (PGs) 82, each of which includes a plurality of cells 83 as previously described with reference to FIG. 4. In a PGC 81 for a menu, programs 82 of a still image or moving image are continuously reproduced to complete a menu of one title. A PGC 81 for a title set corresponds to a chapter in a story comprising a plurality of programs 82, and a movie of one title is completed by continuously reproducing programs 82 in that PGC 81.

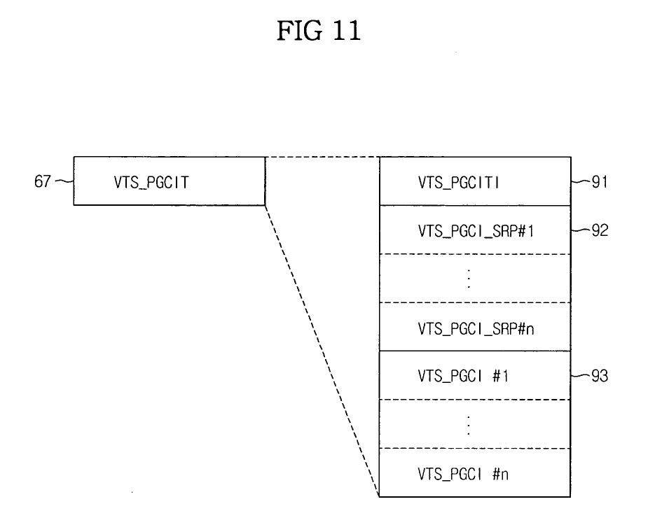

The VTS_PGCIT 67 has information regarding VTS_PGC. As shown in FIG. 11, VTS_PGC information table information (VTS_PGCITI) 91 is described at the head of the VTS_PGCIT 67 and VTS_PGCI search pointers (VTS_PGCI_SRP) 92 of the same number as that of the VTS_PGC are described in the VTS_PGCIT 67 subsequently to the VTS_PGCITI 91. Finally, VTS_PGC information (VTS_PGCI) 93 of the same number as that of the VTS_PGC are described in the VTS_PGCIT 67. The number of the VTS_PGCI search pointers and an end address of the VTS_PGCIT 67 are described in the VTS_PGCITI 91. A category of each VTS_PGC and a start address of each VTS_PGCI 93 are described in the corresponding VTS_PGCI_SRP 92. General information of the PGC 81 is described in the VTS_PGCI 93.

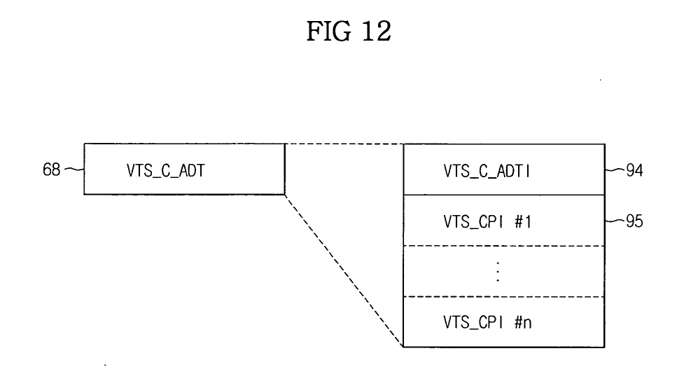

Described in the VTS_C_ADT 68 are start and end addresses of all cells 83 in the VTSTT_VOBS 63. That is, the VTS_C_ADT 68 has, as shown in FIG. 12, VTS cell address table information (VTS_C_ADTI) 94 at the head thereof, which is followed by VTS cell piece information (VTS_CPI) 95. Here, a cell piece constitutes one cell when the cell belongs to a VOB 51 placed in a continuous block, and one interleaved unit (ILVU) when the cell belongs to a VOB 51 placed in an interleaved block.

The VTS_C_ADTI 94 comprises the ID numbers of the VOBs 51 in the VTSTT_VOBS 63 and an end address of the VTS_C_ADT 68. Each VTS_CPI 95 comprises start and end addresses of the corresponding VTS_CP and a VOB ID number and cell ID number for the corresponding VTS_CP.

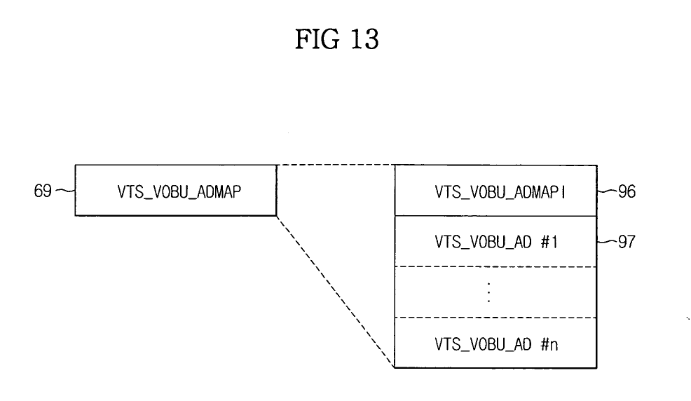

The VTS_VOBU_ADMAP 69 comprises start addresses of all VOBUs 53 in the VTSTT_VOBS 63. Namely, VTS_VOBU address map information (VTS_VOBU_ADMAPI) 96 and addresses of VTS_VOBU (VTS_VOBU_AD) 97 are described in the VTS_VOBU_ADMAP 69, as shown in FIG. 13.

The VTS_VOBU_ADMAPI 96 contains an end address of the VTS_VOBU_ADMAP, and each VTS_VOBU_AD 97 contains a start address of VTS_VOBU for a VOBU #n.

Among the items comprising the VTS 60 other than the VTSI 61, the VTSM_VOBS 62 and VTSTT_VOBS 63 have the same structures as the VOBS structure of the VMGM_VOBS 42 as described above, and the VTSI_BUP 64 comprises the same items as those of the VTSI 61.

Meanwhile, when an image is recorded on a DVD-R/RW in DVD-video format, the VTSI 61, VOBSs 62 and 63 and VTSI_BUP 64 are created as stated above. At this time, provided that the title control information, or VTSI 61, is not correctly recorded on the DVD-R/RW even though the VOBSs 62 and 63 are correctly recorded on the DVD-R/RW, it is impossible for an associated DVD recorder or a general DVD player to reproduce the image recorded on the DVD-R/RW after finalizing the DVD-R/RW. According to an embodiment of the present invention, the DVD recorder records an image on the DVD-R/RW, and then checks whether the VTSI 61 has been correctly recorded on the DVD-R/RW, before finalizing the DVD-R/RW. Therefore, it is possible to prevent a failure to reproduce the image recorded on the DVD-R/RW after the finalization is performed.

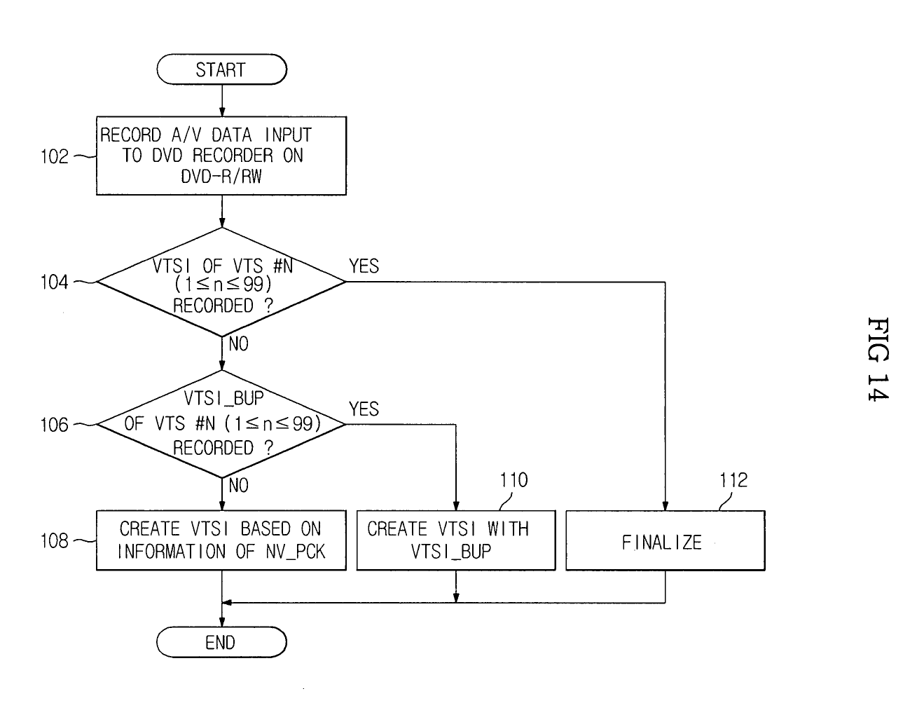

A description will hereinafter be given of a method for, by the DVD recorder of FIG. 1, determining whether VTSI has been correctly recorded on the DVD-R/RW before finalization and creating the VTSI if it has not been correctly recorded, with reference to FIG. 14. In the recording mode, the DVD recorder records an A/V signal input thereto on the DVD-R/RW in the DVD-video format at step 102. If the recording is completed, the DVD drive 13 reads data from the DVD-R/RW and transfers the read data to the recording checker 17 of the controller 16.

The recording checker 17 checks the data transferred from the DVD drive 13 to determine whether VTSI 61 of a VTS #n (1≦n≦99, where n is a natural number) has been correctly recorded at step 104. If all essential items of the VTSI 61 have been recorded, the recording checker 17 determines that the VTSI 61 of the VTS #n has been correctly recorded.

Provided that the VTSI 61 of the VTS #n has been correctly recorded, the DVD recorder or general DVD player will be able to reproduce an image recorded on the DVD-R/RW even though the DVD recorder finalizes the DVD-R/RW. Thus, the DVD recorder determines information of a title #n to have been correctly recorded and then performs the finalization at step 112.

However, if the VTSI 61 is determined not to have been correctly recorded at step 104, the recording checker 17 determines whether VTSI_BUP 64 of the VTS #n has been correctly recorded at step 106. Similarly, when all the essential items of the VTSI 61 have been recorded, the recording checker 17 determines that the VTSI_BUP 64 of the VTS #n has been correctly recorded. Where the VTSI 61 has not been correctly recorded, but the VTSI_BUP 64 has been correctly recorded, the title information creator 19 determines that a problem may occur when the title #n is reproduced after the finalization is performed, and then creates the VTSI 61 with the same contents as those of the VTSI_BUP 64 at step 110.

On the other hand, in the case where neither of the VTSI 61 and VTSI_BUP 64 has been correctly recorded, the title information creator 19 determines that the title #n has been erroneously recorded and then creates the VTSI 61 based on information of NV_PCK 54 at step 108.

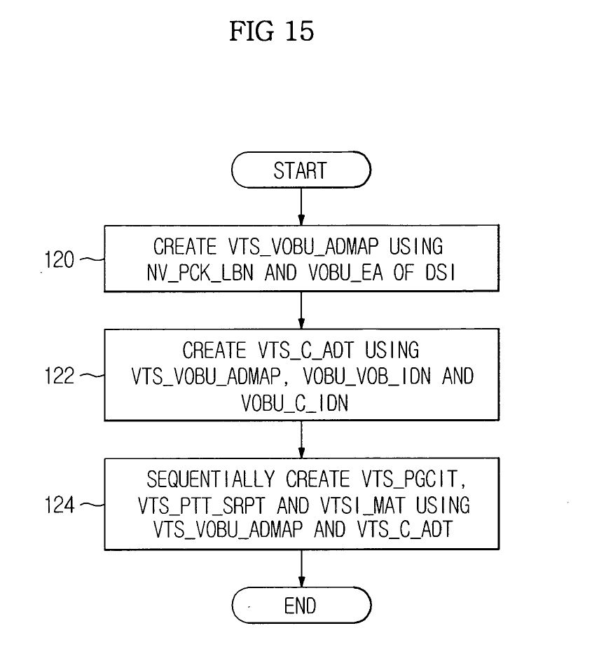

Next, an operation of creating the VTSI 61 based on the information of the NV_PCK 54 by the title information creator 19 will be described in detail with reference to FIG. 15, on the assumption that various data are sequentially recorded on the DVD-R/RW. In order to create the essential items of the VTSI 61 using the information of the NV_PCK 54, the title information creator 19 first obtains start and end addresses of each VOBU 53 using NV_PCK_LBN and VOBU_EA of DSI_GI. At this time, a start address of the NV_PCK 54 is the start address of each VOBU 53 because the NV_PCK 54 is positioned at the head of each VOBU 53. If the title information creator 19 obtains the start and end addresses of each VOBU 53, then it can create VTS_VOBU_AD containing start addresses of VTS_VOBU (see FIG. 13). The title information creator 19 can also readily obtain VTS_VOBU_ADMAPI of VTS_VOBU_ADMAP 69 in consideration of the number of bytes of the VTS_VOBU_AD, so that it can create the VTS_VOBU_ADMAP at step 120.

Next, the title information creator 19 creates VTS_C_ADT 68 using the created VTS_VOBU_ADMAP 69 and VOBU_VOB_IDN and VOBU_C_IDN of the DSI_GI at step 122. The VTS_C_ADT 68 mainly comprises start and end addresses of VTS_CP and VOB ID numbers and cell ID numbers for the VTS_CP (see VTS_CPI 95 in FIG. 12). The title information creator 19 can create the VTS_CPI 95 on the basis of the already known VTS_VOBU_ADMAP 69, VOBU_VOB_IDN and VOBU_C_IDN.

For example, in the case where an arbitrary VOB 51 of a VTS 60 to which VTSI 61 to be created belongs is composed of one cell 52 (in this case, a cell piece is the same as the cell) and the cell 52 has a plurality of VOBUs 53, the title information creator 19 obtains start and end addresses of the cell piece by setting a start address of the first VOBU 53 of the cell piece as the start address of the cell piece and an end address of the last VOBU 53 of the cell piece as the end address of the cell piece, respectively, because it knows an arrangement order of the VOBUs 53 and start and end addresses of each of the VOBUs 53. The title information creator 19 can create VTS. CPI 95 because it already knows a VOB ID number and cell ID number for the cell piece from DSI_GI. The title information creator 19 can also readily obtain VTS_C_ADTI 94 of VTS_C_ADT 68 in consideration of the number of bytes of the VTS_CPI 95, so that it can create the VTS_C_ADT 68.

If the VTS_VOBU_ADMAP 69 and VTS_C_ADT 68 are created, then the title information creator 19 creates VTS_PGCIT 67 of the VTSI 61 using those two pieces of information. One main content of the VTS_PGCIT 67 is a start address of VTS_PGCI 93. Since the title information creator 19 knows various information regarding cells 52 and information regarding a PGC 81 composed of the cells 52, it can obtain the contents of PGCI using those information and create the VTS_PGCIT 67 based on the obtained contents. For example, it is possible to obtain a PGC playback time PGC_PB_TM of PGC_GI (a constituent element of the PGCI) using a playback time of a VOBU 53 belonging to the PGC.

If the VTS_VOBU_ADMAP 69, VTS_C_ADT 68 and VTS_PGCIT 67 are obtained, then the title information creator 19 creates VTS_PTT_SRPT 66. One main content of the VTS_PTT_SRPT 66 is PTT_SRP 75. The contents of the PTT_SRP 75, a PGCN and PGN, can also be obtained using the information regarding the cells 52 and the information regarding the PGC, as in the VTS_PGCIT 67.

If the VTS_VOBU_ADMAP 69, VTS_C_ADT 68, VTS_PGCIT 67 and VTS_PTT_SRPT 66 are obtained, then the title information creator 19 creates VTSI_MAT 65 with reference to them at step 124.

As described above, provided that the VTS_VOBU_ADMAP 69 and VTS_C_ADT 68 are created (i.e., if the information regarding the VOBUs 53 and cells 52 are obtained), the title information creator 19 can logically create the other essential items of the VTSI 61, the VTS_PGCIT 67, VTS_PTT_SRPT 66 and VTSI_MAT 65, using those two pieces of information. That is, because the VTS_VOBU_ADMAP 69 and VTS_C_ADT 68 have all information necessary for the construction of the other essential items, not created yet, the VTS_PGCIT 67, VTS_PTT_SRPT 66 and VTSI_MAT 65, the other essential items can be created on the basis of that information. At this time, the title information creator 19 creates the essential items according to a predefined logic, and carries out the next logic by setting a default value in desired information as needed.

Although the present invention has been disclosed to be applied to the DVD recorder and DVD-R/RW for the convenience of description in the present embodiment, it is not limited thereto. For example, the present invention may be applied to all devices which perform the finalization such as a DVD camcorder which performs the finalization.

As is apparent from the above description, the present invention provides an image recording apparatus which is capable of determining whether title information has been correctly recorded on a DVD-R/RW before finalization and, if the title information has not been correctly recorded, automatically creating the title information, thereby making it possible to avoid failing to reproduce the DVD-R/RW after the finalization.

Although a few embodiments of the present invention have been shown and described, it should be appreciated by those skilled in the art that changes may be made in these embodiments without departing from the principles and spirit of the invention, the scope of which is defined in the claims and their equivalents.

What is claimed is:

1. A title information creation method of an image recording apparatus which records an image on a digital versatile disc (DVD) and finalizes the DVD for compatibility between the DVD and a player, comprising:
determining whether title information has been correctly recorded on the DVD before the finalization; and
creating the title information using different information recorded on the DVD if the title information has not been correctly recorded.

2. The title information creation method as set forth in claim 1, wherein the title information is video title set information.

3. The title information creation method as set forth in claim 2, wherein, if a backup of the video title set information has been recorded on the DVD, the different information is the backup of the video title set information.

4. The title information creation method as set forth in claim 2, wherein the step of creating the title information comprises creating the video title set information using information recorded in a navigation pack of a video object if neither the video title set information nor the backup of the video title set information has been recorded.

5. The title information creation method as set forth in claim 4, wherein the step of creating the video title set information comprises creating a video title set video object unit address map using the number of logical blocks of the navigation pack and an end address of a video object unit recorded in the navigation pack.

6. The title information creation method as set forth in claim 5, wherein the step of creating the video title set information further comprises creating a video title set cell address table using the video title set video object unit address map and a video object identification (ID) number of the video object unit and a cell ID number of the video object unit recorded in the navigation pack.

7. The title information creation method as set forth in claim 6, wherein the step of creating the video title set information further comprises sequentially creating a video title set program chain information table, a video title set part_of_title search pointer table and a video title set information manager table using the video title set video object unit address map and video title set cell address table.

8. The title information creation method as set forth in claim 2, wherein the step of determining comprises determining that the video title set information has been correctly recorded, when all essential items of the video title set information have been described.

9. An image recording apparatus for recording an image on a digital versatile disc (DVD) and finalizing the DVD for compatibility between the DVD and a player, the image recording apparatus having a title information creation function, the apparatus comprising:
a controller for determining whether title information has been correctly recorded on the DVD before the finalization; and
a title information creator for creating the title information using different information recorded on the DVD if the title information has not been correctly recorded.

10. The image recording apparatus as set forth in claim 9, wherein the title information is video title set information.

11. The image recording apparatus as set forth in claim 10, wherein the title information creator is adapted to create the video title set information using a backup of the video title set information or information recorded in a navigation pack of a video object.

12. The image recording apparatus as set forth in claim 9, wherein the DVD is a DVD-recordable (DVD-R) or DVD-rewriteable (DVD-RW).

13. The image recording apparatus as set forth in claim 9, further comprising:
a display for displaying a result of the determination by the controller to a user.

14. The image recording apparatus as set forth in claim 9, wherein the controller comprises a recording checker.
